(19) United States
(12) Patent Application Publication
(10) Pub. No.: US 2013/0159055 A1
(43) Pub. Date: Jun. 20, 2013

(54) SYSTEM AND METHOD FOR EMPLOYING SELF-OPTIMIZING ALGORITHMS TO PROBE AND REACH REGIONS OF HIGHER CUSTOMER SATISFACTION THROUGH ALTERED SYSTEM PARAMETERS ON SURVEY RESULTS

(71) Applicants: Vedran LERENC, Schoenau (DE); Jens LEHMANN, Sunnyvale, CA (US); David SOMMER, Bruehl (DE)

(72) Inventors: Vedran LERENC, Schoenau (DE); Jens LEHMANN, Sunnyvale, CA (US); David SOMMER, Bruehl (DE)

(73) Assignee: SAP AG, Walldorf (DE)

(21) Appl. No.: 13/331,066

(22) Filed: Dec. 20, 2011

(51) Int. Cl. G06Q 30/02

(52) U.S. Cl. 705/7.32

(57) ABSTRACT

A system and method described herein provide for the generation of self-optimization algorithms from user survey results for a complex system, such as a matching algorithm for a trip sharing service. User feedback surveys are generated and transmitted to users of the complex system to obtain feedback on a user's experience using the complex system. Survey results from completed surveys are compiled to demonstrate statistical evidence of alternations that can be made to adjust the settings of the complex system. The system and method may use the generated alternations by the complex system to modify the settings of the complex system.

### FIELD OF THE INVENTION

The present invention relates to a process for generating optimization algorithms for a complex system. The present invention further relates to optimizing a complex system based on survey results generated for the complex system. The present invention further relates to a complex system that modifies its own settings based on survey results by users of the complex system. The present invention further relates to optimizing a complex system based on self-optimizing algorithms generated by survey results of users of the complex system.

### BACKGROUND INFORMATION

The following co-pending applications are hereby incorporated by reference herein: U.S. patent application Ser. No. 12/643,165 (“the '165 application”), filed Dec. 21, 2009, and U.S. patent application Ser. No. 12/730,973 (“the '972 application”), filed Mar. 24, 2010.

Computer-based applications can be designed to incorporate complex systems into the applications. A complex system itself may encompass a plurality of interconnected parts, the system together exhibiting certain properties that are not readily apparent from the individual parts of the complex system. The equations from which complex systems are developed can represent organized but unpredictable behaviors of systems of nature that are considered complex. Complex systems can effectively demonstrate how certain relationships between the individual parts lead to the collective behaviors of a system and how the system interacts and forms relationships with its environment.

A trip sharing service, such as that described in the '165 application, is an example of an application that may incorporate a complex system that may be effectively implemented within a computer-based application. A program, as described in the '165 application, can generate a shared trip for drivers and passengers based on receiving a service request for a potential trip and matching the service request to a preexisting trip. Matches that are made from a service request to an existing trip are made based on parameters that have been set by a designer. The trip service may be designed to maximize the users' convenience in the organization of shared trips, by finding an appropriate trip for a user, as well as appropriate passengers on each trip. The trip sharing service, such as that described in the '165 application, may be designed to evaluate a multitude of user preferences for the arrangement of a shared trip.

User preference may be provided for the trip sharing service by a user upon the creation of a user profile. Attributes of the user profile may be used to generate the user preferences for matching of the trip sharing service. In some instances, a particular match made by the trip sharing service may not be a particularly great fit for a user. This may be due to a variety of reasons, such as: personality conflicts between passengers in a particular trip, dissatisfaction with the route selected, dissatisfaction with the number of stops of the shared trip, dissatisfaction with the travel time of the trip, dissatisfaction with the driver's driving style and speed, or dissatisfaction with other aspects of the trip. In the present implementation, the satisfaction or dissatisfaction of the individual user is not factored into the designed shared trips. Thus, a user's dissatisfaction with the generated shared trip may be ignored and not taken into account by the designed program.

Various changes to the trip sharing service can be made by a designer, although a designer may only change general settings of the trip service. However, any general changes to the overall settings of the trip service may not have an actual effect on the experiences of the individual users, as broad changes made by a designer do not take into account individual customer satisfaction, preventing an actual optimization of the trip service for the individual users. These general setting changes made to the complex system (trip sharing service algorithms) may not incorporate modifications needed for optimizing the system for each individual user. Furthermore, having a designer making modifications to the complex system is an inefficient method of altering the complex system.

Thus, there remains a need in the art for a system and method for a complex system to generate its own optimization algorithms to optimize the complex system. There also remains a need in the art for a system and method to incorporate individual user feedback into the optimization of a complex system. There also remains a need in the art for a trip sharing service to modify its own settings based on user feedback of the service to lead to an efficient optimization of the trip sharing service.

### SUMMARY OF THE INVENTION

A system and method described herein provide for the generation of self-optimization algorithms from user survey results for a complex system, such as a matching algorithm for a trip sharing service. User feedback surveys are generated and transmitted to users of the complex system to obtain feedback on a user's experience using the complex system. Survey results from completed surveys are compiled to demonstrate statistical evidence of alternations that can be made to adjust the settings of the complex system. The system and method may use the generated alternations by the complex system to modify the settings of the complex system.

In particular, the exemplary embodiments and/or exemplary methods of the present invention are directed to a method for self-optimizing a complex system. The method includes transmitting a user survey to an application on a user terminal, whereupon completion of the user survey, survey results are retrieved from the application on the user terminal and compiled with survey results of other users. A determination may be made based on the survey results of an alternation, and the settings of the complex system are modified to incorporate the alternation. In the system and method, it may be determined that a total number of received surveys support the determined alternation. The settings of the complex system are not modified if the total number of received surveys does not support the determined alternation.

The exemplary embodiments and/or exemplary methods of the present invention are also directed to a method for self-optimizing a complex system based on a determination of an alternation for an individual user. The method includes receiving a service request from an application on a user terminal and determining whether an alternation has been implemented for the individual user. If an alternation exists for the individual user, it may be retrieved. If an alternation does not exist for the individual user, a new alternation may be created. Both the alternation and any new alternation can be stored in a separate database for later retrieval. The retrieved alternation can be applied to settings of the complex system and the service request is processed. If a new alternation is created, the new alternation can be applied to the settings of the complex system before processing of the service request. After processing occurs, the processed service request and a user survey are transmitted to the application on the user terminal.

The exemplary embodiments and/or exemplary methods of the present invention are also directed to a method for self-optimizing a complex system for all users of the complex system. The method includes receiving survey results from an individual user on an application on a user terminal and retrieving an alternation for the individual user. A determination can be made of all users that share the same alternation with the user. After a subset of users sharing the alternation is identified, the efficacy of the alternation for the subset of users can be made.

In the system and method, if the alternation is determined to be statistically indistinct for a prolonged duration, the alternation is deleted for the subset of users. In this instance, the alternation is remembered by the complex system as an ineffective alternation. If the alternation is determined to be ineffective for the subset of users, the alternation is deleted for the subset of users. The alternation can also be remembered by the complex system as an ineffective alternation.

If the alternation is determined to be effective for the subset of users, a further determination can be made as to the efficacy of the alternation for all users of the complex system. If the alternation is determined to be effective for all users of the complex system, the alternation is implemented to modify settings for all users of the complex system. If the alternation is determined to be ineffective for all users of the complex system, the alternation can be implemented for a group of users larger than the subset of users, to determine the efficacy of that group.

The exemplary embodiments and/or exemplary methods of the present invention are also directed to a self-optimizing complex system and/or a computer system displaying an application depicting the self-optimizing complex system. These systems may include at least one user terminal transmitting survey results to a server and a server configured to perform the method of self-optimizing the complex system. These systems may also include a memory storing executable code comprising instructions to perform the method of self-optimizing the complex system.

### BRIEF DESCRIPTION OF THE DRAWINGS

FIG. 1 is a diagram of the complex system displayed on an application on a user terminal according to an embodiment of the present invention.

FIG. 2 is a diagram of the process of matching a user with an existing trip in a trip sharing service according to an embodiment of the present invention.

FIG. 3 is an example embodiment of a survey displayed on an application on a user terminal according to an embodiment of the present invention.

FIG. 4 is an alternate embodiment of a survey displayed on an application on a user terminal according to an embodiment of the present invention.

FIG. 5 is a diagram of the process of optimizing the settings of the complex system based on completed survey results according to an embodiment of the present invention.

FIG. 6 is a diagram of the process of configuring the settings of the complex system for an individual user of the complex system according to an embodiment of the present invention.

FIG. 7 is a diagram of the process of optimizing the settings of the complex system by testing an alternation based on an individual survey result for suitability for the entire complex system according to an embodiment of the present invention.

### DETAILED DESCRIPTION

The subject invention will now be described in detail for specific preferred embodiments of the invention, it being understood that these embodiments are intended only as illustrative examples and the invention is not to be limited thereto.

Modifying settings of a complex system by a system designer is an inefficient method for altering a complex system and will generally not lead to an optimization of the system. Using a system designer to modify settings is costly and may lead to decreased traffic for an application incorporating the complex system. Exemplary embodiments of the present invention provide a system and method that allow for the generation of optimization algorithms by the complex system that are used by the complex system for self-optimization. A user feedback survey is generated and transmitted to users of a complex system to obtain feedback on a user's experience using the complex system. Survey results from completed surveys are compiled to demonstrate statistical evidence of alternations that can be made to adjust the settings of the complex system. The system and method may use the generated alternations by the complex system to modify the settings of the complex system.

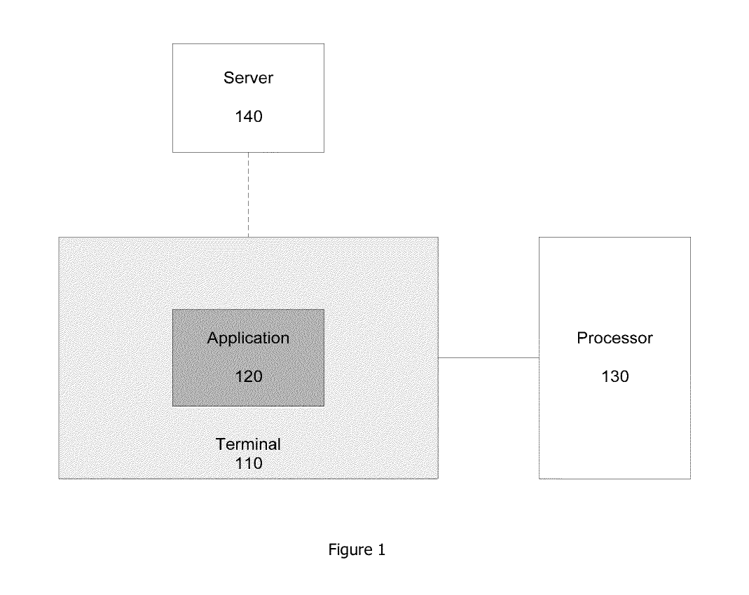

FIG. 1 illustrates a diagram of a user terminal 110 displaying a client application 120 on the terminal. Application 120 may be executed, for example, by a processor 130 and may be displayed on user terminal 110 to a user. The client application 120 displayed on the user terminal 110 may connect to server 140 illustrated in FIG. 1. User terminal 110, may be embodied, for example, as a desktop, laptop, hand-held device, personal digital assistant (PDA), television set-top Internet appliance, mobile telephone, smart phone, iPod™, iPhone™, iPad™, etc., or as a combination of one or more thereof, or other comparable device.

In an example embodiment, application 120 may be a web application that is implemented on a back end component and displayed on a user interface on user terminal 110. In another embodiment, the application may be a computer-based application stored locally and displayed on terminal 110. In another embodiment, application 120 may be an application specifically designed and configured for a hand-held device, mobile telephone, smart phone, iPod™, iPhone™, or iPad™.

In an example embodiment, the system and method may include one or more processors 130, which may be implemented using any conventional processing circuit and device or combination thereof, e.g., a central processing unit (CPU) of a personal computer (PC) or other workstation processor, to execute code provided, e.g., on a hardware computer-readable storage medium including any conventional memory device, to perform any of the methods described herein, alone or in combination. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

The system may include server 140 which may interact with user terminal 110. Server 140 may be implemented locally or remotely using processing circuits or devices or combinations thereof, such as, for example, a central processing unit (CPU) of a personal computer (PC) or other workstation processor, such as processor 130. User terminal 110 may connect to server 140 through a computer network or a wireless network such as a cellular network, WLAN network, short range communication network (i.e. BLUETOOTH®) or a combination of different wired and/or wireless networks.

Server 140 may include one or more databases to collect and store generated user profiles and preferences for each of the users of the complex system. In an example embodiment where the complex system is incorporated into an application such as a trip sharing service, each stored user profile may contain information including, but not limited to, age of user, a user's driving preferences, a user's driving speed preferences, a user's smoking preferences, a user's music preferences, or any other behavior or identifying data of a user.

Application 120 may be designed to incorporate a desired complex system and users of the complex system on terminal 110. In an example embodiment, application 120 may be a trip sharing service, such as that described in the '165 application. In this example embodiment, a user may use application 120 to match the user with a preexisting trip by submitting a request on application 120. In an example embodiment, application 120 may be a calendar application.

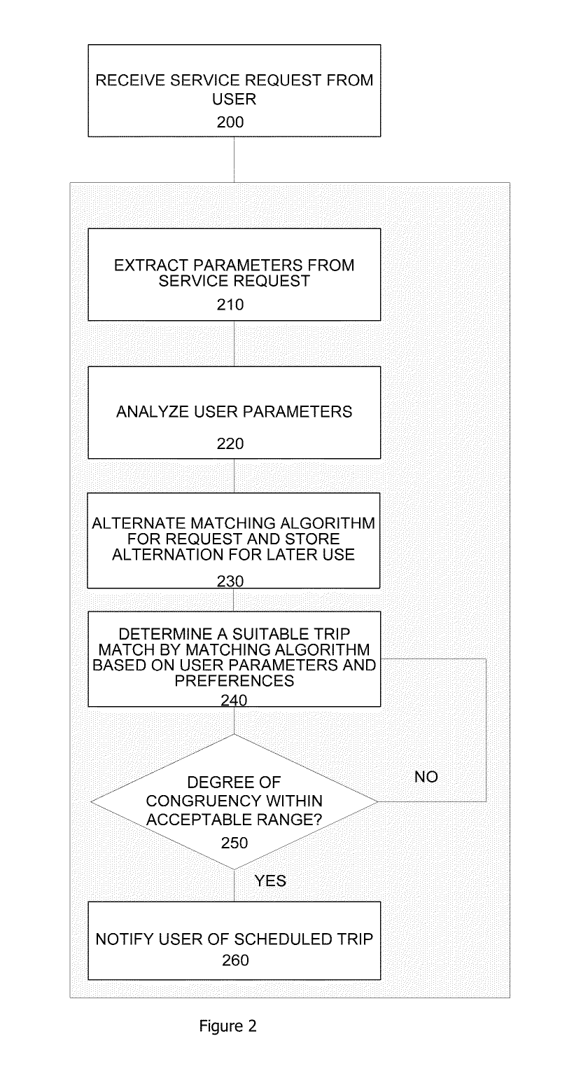

FIG. 2 illustrates diagram of the process of matching a user with an existing trip in a trip sharing service. Application 120 may transmit a service request to server 140 and server 140 may receive the request in step 200. On the service request, a user may input various parameters including a desired starting and ending location and a total number of stops. In step 210, server 140 may extract the inputted parameters from the service request and analyze the parameters in step 220. In step 230, an alternation may be made for the matching algorithm for the service request. The system may store the alternation in a database for later use. A match for an existing trip may be made for the user on server 140 based on a matching algorithm, the user's preferences, and the received parameters in step 240. The matching algorithm may be a complex system that may determine a combination of drivers and passengers for a suitable trip based on specific settings such as, for example, acceptable detour time, an acceptable range to walk to a meeting point, an acceptable range to walk from a dropoff point, an acceptable loading and dropoff time for the potential passengers and driver. These setting may be initialized by a designer. If a suitable trip is found, a degree of congruency may be determined between the user and a potential driver or potential passengers on the suitable trip in step 250. If the degree of congruency is determined to be within an acceptable range, the match may be executed. If the degree of congruency is not determined to be within an acceptable range, the system may revert back to step 240 to find another suitable trip. If an executed match is found to be within an acceptable degree of congruency, a notification of the scheduled trip may be transmitted from server 140 back to terminal 110 in step 260, notifying the user of the scheduled trip.

In an exemplary embodiment of the present invention, the complex system depicted in application 120 may be configured to allow for the complex system to alter its own settings. In the example embodiment where application 120 is a trip sharing service, after a scheduled trip has taken place, a user survey may be transmitted to the user on terminal 110 to determine the user's satisfaction with the completed trip. The survey may be generated by server 140 and transmitted to terminal 110 through various mediums. In an example embodiment, the user survey may be automatically triggered by application 120 after the completed trip. In an example embodiment, the survey may be displayed on a web page. In an embodiment, a user may be given a URL address to the web page hosting the survey. In another embodiment, a user may be given a link to the web page hosting the survey.

In an example embodiment, an email may be sent to a user's registered email address. In an embodiment, the body of the email may include the survey requesting information from the user. A user may complete the survey by replying, via email, to the transmitting email address, replying directly to the contents of the survey. In another embodiment, an email may include a URL address to a web page hosting the survey. In another embodiment, an email may include a link to a web page hosting the survey.

In an example embodiment, the survey may be embedded on a mobile application that may be displayed on an interface of user terminal 110 when, for example, user terminal 110 is a mobile or portable device.

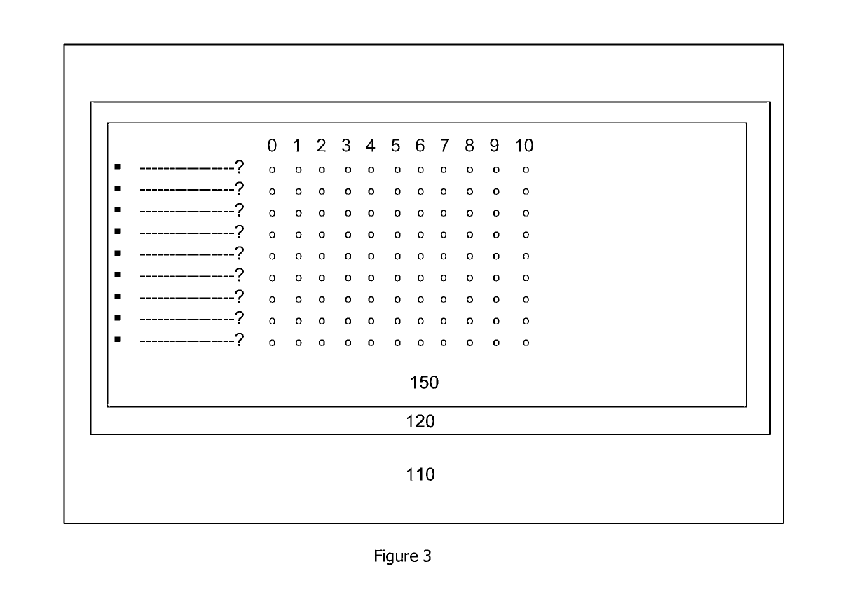

FIG. 3 illustrates an example embodiment user survey transmitted to a user of the complex system that is displayed in application 120. In the example embodiment in FIG. 3, the survey 150 transmitted to the user may be embedded in application 120 and displayed to a user on user terminal 110. In an embodiment, survey 150 may consist of a single question that asks a user about their general satisfaction of a completed trip. A user may provide a metric grade to reflect their level of satisfaction of the ride, on a range from 0 to 10. In an alternate embodiment, as illustrated in FIG. 3, survey 150 may consist of a sequence of questions asking the user about their experience of the completed trip. In an embodiment, the survey may, for example, consist of a sequence of questions that ask a user to provide a metric grade to reflect their level of satisfaction of the ride, on a range of 0 to 10 for a number of categories. These categories may cover a number of variables which may be further fine tuned by the system. These categories may include, but are not limited to: “Pleasantness of trip”, “Satisfaction with the driver”, “Satisfaction with other passengers”, “Satisfaction of the driving speed”, “Satisfaction of the duration of the trip”, “Satisfaction with the meeting point”, “Satisfaction with the dropoff point”, “Comfort in the vehicle”, “Satisfaction with the environment in the vehicle”, “Satisfaction with the vehicle driven”, and “Satisfaction with the amount of walking”.

The questions asked on survey 150 illustrated in FIG. 3, may be broken down into specific questions that may be further grouped into clusters pertaining to similar parameters. For example, questions asking about “Satisfaction with the driver”, “Satisfaction with other passengers”, or questions about personality conflicts with other passengers, may be grouped, for example, in a cluster of parameters pertaining to “Interaction with passengers”. In another example, questions asking about “Comfort in the vehicle”, “Satisfaction with the environment in the vehicle”, or “Satisfaction with the vehicle driven” can be grouped, for example, into a cluster of parameters pertaining to “Vehicle Preferences”.

Survey 150 may include numeric headings from the integers 0 to 10, as headings to the survey. In an embodiment, a designation of 0 may refer to a lowest level of satisfaction for a user. In an embodiment, the designation of 10 may refer to a highest level of satisfaction for the user. A user may indicate their satisfaction with a corresponding category by clicking on a click circle button corresponding to the numeral representing their satisfaction with the category. In an embodiment, the user may only click on once click circle button for each designated category.

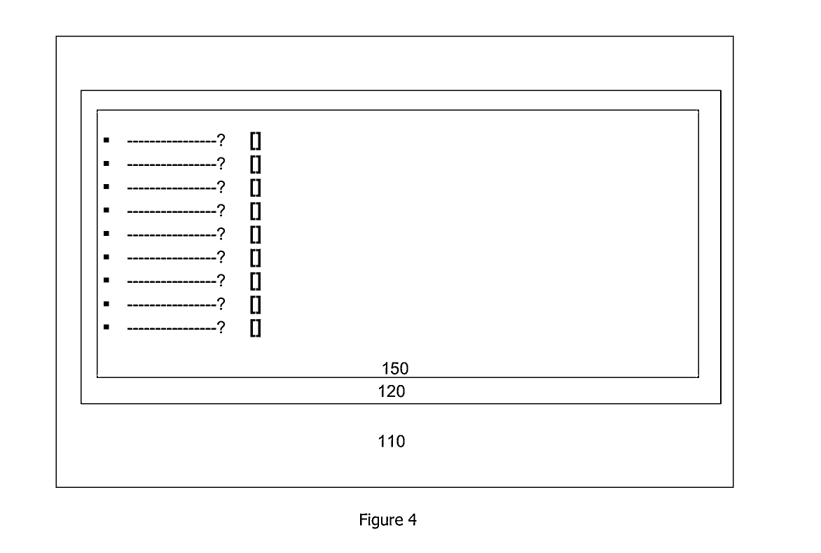

FIG. 4 illustrates another example embodiment user survey transmitted to a user of the complex system that is displayed in application 120. In the example embodiment in FIG. 4, the survey 150 transmitted to the user may be embedded in application 120 and displayed to a user on user terminal 110. In an embodiment, survey 150 may consist of a single question that asks a user about their general satisfaction of a completed trip. A user may provide a metric grade to reflect their level of satisfaction of the ride, on a range from 0 to 10. In an alternate embodiment, as illustrated in FIG. 4, survey 150 may consist of a sequence of questions asking the user about their experience of the completed trip. In an embodiment, the survey may, for example, consist of a sequence of questions that ask a user to provide a metric grade to reflect their level of satisfaction of the ride, on a range of 0 to 10 for a number of categories. These categories may cover a number of variables which may be further fine tuned by the system. These categories may include, but are not limited to: “Pleasantness of trip”, “Satisfaction with the driver”, “Satisfaction with other passengers”, “Satisfaction of the driving speed”, “Satisfaction of the duration of the trip”, “Satisfaction with the meeting point”, “Satisfaction with the dropoff point”, “Comfort in the vehicle”, “Satisfaction with the environment in the vehicle”, “Satisfaction with the vehicle driven”, and “Satisfaction with the amount of walking”.

The questions asked on survey 150 illustrated in FIG. 4, may be broken down into specific questions that may be further grouped into clusters. For example, questions asking about “Satisfaction with the driver”, “Satisfaction with other passengers”, or questions about personality conflicts with other passengers, may be grouped, for example, in a cluster of parameters pertaining to “Interaction with passengers”. In another example, questions asking about “Comfort in the vehicle”, “Satisfaction with the environment in the vehicle”, or “Satisfaction with the vehicle driven” can be grouped, for example, into a cluster of parameters pertaining to “Vehicle Preferences”.

Survey 150 may include input fields adjacent to each question category question in the survey, in which the user may input a metric grade. In an embodiment, a designation of 0 may refer to a lowest level of satisfaction for a user. In an embodiment, the designation of 10 may refer to a highest level of satisfaction for the user. A user may indicate their satisfaction with a corresponding category by inputting an integer between 0 and 10 into the adjacent input field for each category. In an embodiment, the user may only enter a single input for each designated category.

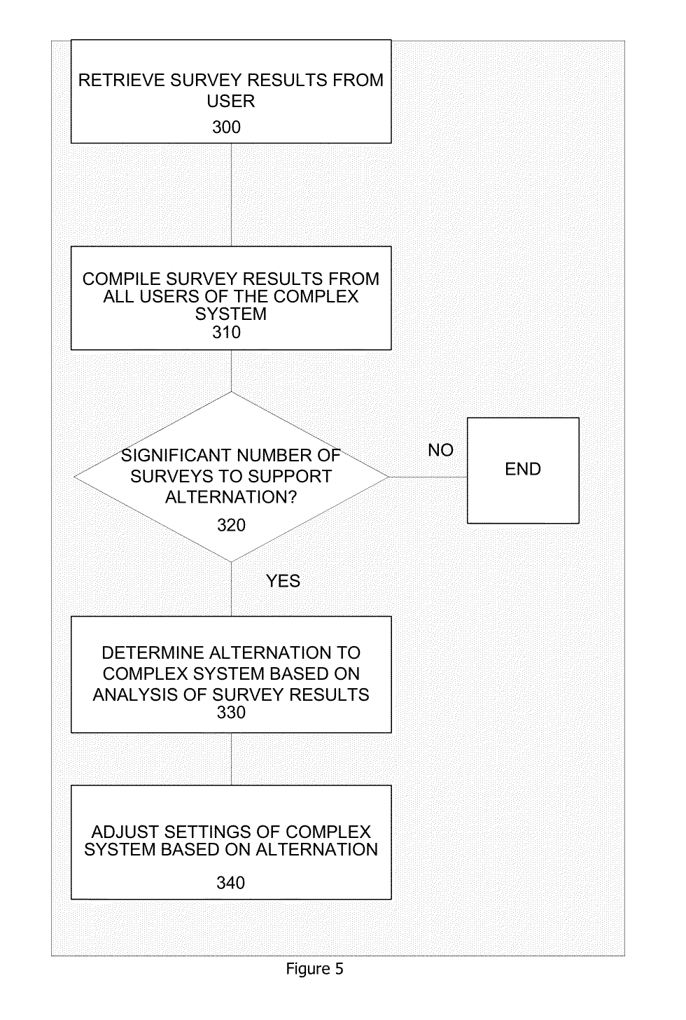

Once a user completes a survey, the survey results may be transmitted from user terminal 110 back to server 140. FIG. 5 illustrates a process for optimizing the settings of the complex system depicted in application 120 based on the completed survey. In step 300, the completed survey result is retrieved by server 140 from user terminal 110. Server 140 may store the survey result from user terminal 110 in one or more databases. Server 140 may also store survey results from other users of the complex system in the database(s). In step 310, server 140 may retrieve the stored survey results from the stored databases and compile all of the survey results. In step 320, the system may determine if there are enough completed surveys to support a possible alternation to the settings of the complex system. If the system determines that there are not enough survey results from users to support a possible alternation, no further action may be taken until, at a later time, the system determines that there are enough surveys to support an alternation. An alternation may be determined for the complex system only if the number of survey results is large enough to show statistical evidence of the effects of the alternation for all users.

If in step 320 the system determines there are enough survey results from users of the complex system to support the alternation, the system may move to step 330. In step 330, the compiled survey results may be analyzed by the system and an alternation may be determined from the survey results. In step 340, the systems may adjust the settings of the complex system by incorporating the determined alternation. Adjustment to the settings of the system may occur through classic optimization strategies such as stochastic algorithms, evolutionary algorithms, probabilistic algorithms, swarm algorithms, or neural algorithms. In an example embodiment where application 120 is a trip sharing service, an alternation may be made to the matching algorithm of the trip sharing service.

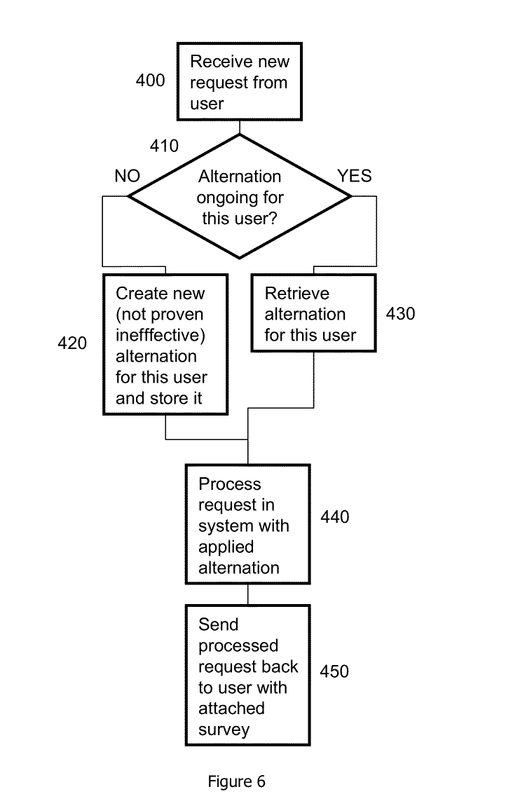

FIG. 6 illustrates an example embodiment of a process for configuring the settings of the complex system depicted in application 120 for an individual user of the complex system, according to an embodiment of the present invention. In the example embodiment illustrated in FIG. 6, alterations may be determined and incorporated for an individual user, wherein a user may make subsequent service requests within the complex system.

In step 400, a new request may be made by a user of the complex system. This request may be transmitted to server 140 from user terminal 110. In step 410, the system may check to see if a previous alternation has been identified and stored in a database for the specific user. If an alternation has not been previously identified and implemented for the user, the system may move to step 420. Conversely, if an alternation has previously been identified and has already been implemented for the user, the system may move to step 430.

In step 420, where it has been determined that an alternation has not been implemented for the user, the system may create a new alternation for the user and store it in a respective database. In an embodiment, the system may record previous alternations that have been determined by the system to be ineffective. In this embodiment, when an alternation is created in step 420, the system may first check that the alternation is not an alternation that has previously been determined by the system to be ineffective. After the system creates a new alternation and stores the alternation, the system may move to step 440.

If the system did find a previously implemented alternation for the user in step 410, the system may proceed to step 430. In step 430, the system may retrieve a stored alternation that has already been implemented for the user. After retrieving the alternation, the system may move to step 440.

In step 440, the system may process the new service request received from the user. The system may implement the newly created or retrieved alternation by modifying the settings of the complex system for the individual user to reflect the alternation. In step 450, the system may send the processed service request back to a user with an accompanying user survey for the user to fill out. The user survey may be generated by the system and transmitted to terminal 110. The new survey may be transmitted to user terminal 110 via an email—including the survey itself, a URL address to a web page hosting the survey, or a link to a web page—or the new survey may be displayed on application 120 or linked to a web page hosting the survey from application 120. In another embodiment, the system may transmit a push notification to a user via a mobile phone, smart phone, or communication device. The push notification may actively solicit feedback from the user for the user's processed service request.

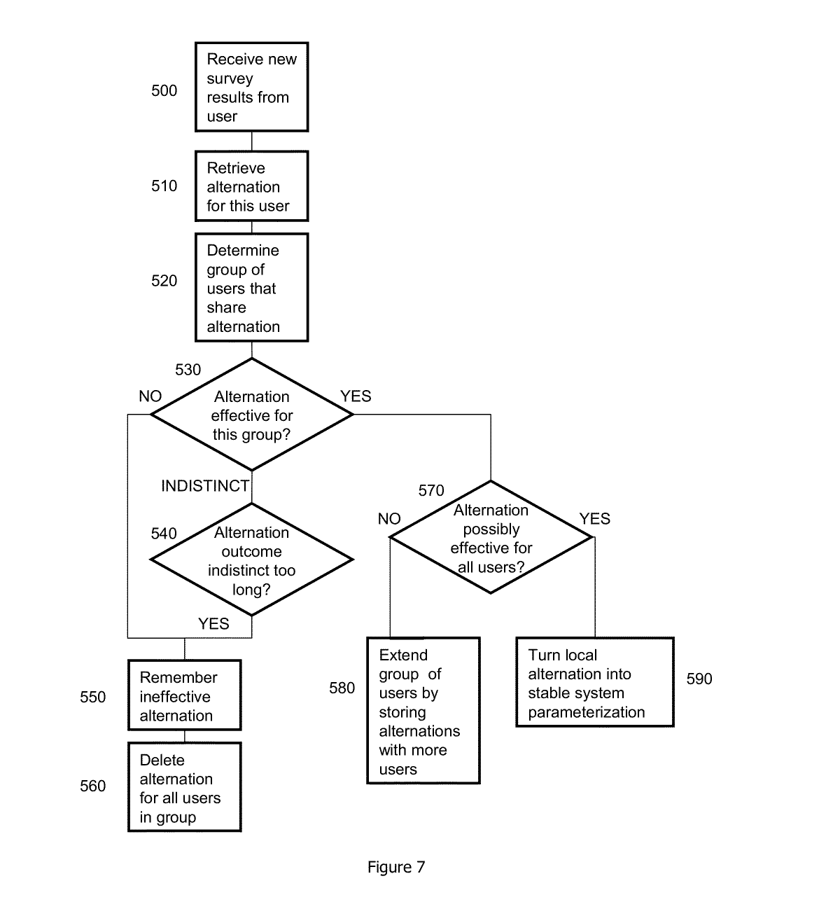

FIG. 7 illustrates an example embodiment of a process for optimizing the settings of the complex system depicted in application 120 by testing an alternation based on an individual survey result for suitability for the entire complex system. In the example embodiment illustrated in FIG. 7, alterations may be determined and incorporated for individual users, wherein the alternations may be further tested for suitability with all users of the complex system to determine if the settings of the complex system should be updated by the alternation.

In step 500, a completed survey result for a service request is retrieved by server 140 from user terminal 110. Server 140 may store the survey result from user terminal 110 in one or more databases and/or retrieve the stored individual survey result from the database(s). In step 510, the system may analyze the survey result from user terminal 110 and retrieve an alternation, if one has been implemented, corresponding to the user. In step 520, the system may also identify other users that may share the same alternation as the user on terminal 110.

In step 530, the system may determine the efficacy of the alternation for the identified group of users with the alternation. The efficacy of the alternation may be determined by compiling and analyzing completed survey results received from the subset group of users. If the alternation was determined to be ineffective in step 530, the system may move to step 550. In step 550, the system may store the ineffective alternation in a database or memory to assist in the future determination of effective alternations for users of the complex system. In step 560, the alternation may be deleted for all users of the subset group of users as determined in step 520. The settings of the complex system for this subset of users may be reverted back to their previous state.

The system may determine that the efficacy of the alternation may not be able to be ascertained in step 530, as the statistical significance of the alternation may not be able to be determined. If the efficacy of the alternation may not be determined, it may be necessary for the system to acquire further feedback to determine the efficacy of the alternation for subset of users. If the efficacy of the alternation remains indistinct for a long period of time, the system may determine in step 540 that the alternation is ineffective for the subset of user. The system may proceed to step 550, where the ineffective alternation is stored to be remembered by the system, and to step 560, where the ineffective alternation is deleted for the subset of users and the settings of the complex system are reverted back to a previous state for the subset of users.

If the alternation is determined by the system to be effective is step 530, the system may move to step 570. In step 570, the system may make a determination as to whether the alternation could be effective for all users of the complex system. If the system determines that the alternation could not be effective for all users of the complex system, the system may move to step 580. In step 580, the system may expand the subset of users with the alternation, enabling the storage of the alternation with a larger subset of users of the complex system.

If the system determines in step 570 that the alternation may be effective for all users, the system may move to step 590. In step 590, the system may turn the local alternation stored with the subset into stable system parameterization for all users of the complex system. The settings of the complex system may be modified for all users to reflect the alternation. Adjustment to the settings of the complex system may occur through classic optimization strategies such as stochastic algorithms, evolutionary algorithms, probabilistic algorithms, swarm algorithms, or neural algorithms.

In an embodiment where the complex system is a trip sharing service, parameters of the matching algorithm for all users may be modified through the process depicted in FIG. 7. In an alternate embodiment where application 120 is a trip sharing service, a user may create a profile upon registration for the trip sharing service. The created profile may include information, which in addition to ride sharing preferences, may contain demographic or personal information about the user's interests. The system may socially cluster users of the complex system based on defining characteristics or inputted interests of the users. The settings of the matching algorithm of the trip sharing service may be adjusted to incorporate the resulting social clusters generated by the system. In another alternate embodiment where application 120 is a trip sharing service, routing and map services may be used to determine the quickest and most efficient travel routes for a user's inputted desired starting location and dropoff location. The settings of the matching algorithm of the trip sharing service may be adjusted to incorporate the data from the routing and map services.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method for self-optimizing a complex system, the method comprising:
transmitting a user survey to an application on a user terminal;
upon completion of the user survey, retrieving survey results from the application on the user terminal;
compiling the survey results with survey results of other users;
determining an alternation to the complex system based on the compiled survey results; and
modifying settings of the complex system to incorporate the alternation.

2. The method according to claim 1, further comprising:
determining that a total number of received surveys support the determined alternation.

3. The method according to claim 2, wherein the settings of the complex system are not modified if the total number of received surveys does not support the determined alternation.

4. A method for self-optimizing a complex system based on a determination of an alternation for an individual user, the method comprising:
receiving a service request from an application on a user terminal;
determining whether an alternation has been implemented for the individual user;
retrieving the alternation for the individual user, wherein if the alternation is not implemented a new alternation is created;
applying the alternation or the new alternation to settings of the complex system, wherein the service request is processed; and
transmitting the processed service request and a user survey to the application on the user terminal.

5. The method according to claim 4, wherein the alternation or the new alternation is stored in a database.

6. A method for self-optimizing a complex system for all users of the complex system, the method comprising:
receiving survey results from an individual user on an application on a user terminal;
retrieving an alternation for the individual user;
determining a subset of users that share the alternation; and
determining an efficacy of the alternation for the subset of users.

7. The method according to claim 6, wherein if the alternation is determined to be statistically indistinct for a prolonged duration the alternation is deleted for the subset of users.

8. The method according to claim 6, wherein if the alternation is determined to be ineffective the alternation is deleted for the subset of users.

9. The method according to claim 6, wherein if the alternation is determined to be effective for the subset of users a determination is made of the efficacy of the alternation for all users of the complex system.

10. The method according to claim 7, wherein the alternation is remembered by the complex system as an ineffective alternation.

11. The method according to claim 8, wherein the alternation is remembered by the complex system as an ineffective alternation.

12. The method according to claim 9, wherein if the alternation is determined to be effective for all users of the complex system the alternation is implemented to modify settings for all users of the complex system.

13. The method according to claim 9, wherein if the alternation is determined to be ineffective for all users of the complex system the alternation is implemented for a group of users larger than the subset of users.

14. A self-optimizing complex system, the system comprising:
at least one user terminal transmitting survey results to a server; and
the server providing the following:
transmitting a user survey to an application on the at least one user terminal;
upon completion of the user survey, retrieving survey results from the application on the at least one user terminal;
compiling the survey results with survey results of other users;
determining an alternation to the complex system based on the compiled survey results; and
modifying settings of the complex system to incorporate the alternation.

15. A self-optimizing complex system, the system comprising:
a user terminal; and
a server connected to the user terminal, the server providing the following:
receiving a service request from an application on the user terminal;
determining whether an alternation has been implemented for the individual user;
retrieving the alternation for the individual user, wherein if the alternation is not implemented a new alternation is created;
applying the alternation or the new alternation to settings of the complex system, wherein the service request is processed; and
transmitting the processed service request and a user survey to the application on the user terminal.

16. A self-optimizing complex system, the system comprising:
a user terminal; and
a server connected to the user terminal, the server providing the following:
receiving survey results from an individual user on an application on the user terminal;
retrieving an alternation for the individual user;
determining a subset of users that share the alternation; and
determining an efficacy of the alternation for the subset of users.

17. The system according to claim 16, wherein an efficacy of the alternation for a larger group of users or all users is determined if the alternation is effective for the subset of users.

18. A computer system displaying an application depicting a self-optimizing complex system, the computer system comprising:
a processor;
a user terminal coupled to the processor; and
a memory storing executable code comprising instructions to:
transmit a user survey to the application on the user terminal;
upon completion of the user survey, retrieve survey results from the application on the user terminal;
compile the survey results with survey results of other users;
determine an alternation to the complex system based on the compiled survey results; and
modify settings of the complex system to incorporate the alternation.

19. A computer system displaying an application depicting a self-optimizing complex system, the computer system comprising:
a processor;
a user terminal coupled to the processor; and
a memory storing executable code comprising instructions to:
receive a service request from the application on the user terminal;
determine whether an alternation has been implemented for the individual user;
retrieve the alternation for the individual user, wherein if the alternation is not implemented a new alternation is created;
apply the alternation or the new alternation to settings of the complex system, wherein the service request is processed; and
transmit the processed service request and a user survey to the application on the user terminal.

20. A computer system displaying an application depicting a self-optimizing complex system, the computer system comprising:
a processor;
a user terminal coupled to the processor; and
a memory storing executable code comprising instructions to:
receive survey results from an individual user on the application on the user terminal;
retrieve an alternation for the individual user;
determine a subset of users that share the alternation; and
determine an efficacy of the alternation for the subset of users.

21. A computer readable medium having a computer program which is executable by a processor for self-optimizing a complex system, the computer readable medium comprising:
an arrangement providing the following:
transmitting a user survey to an application on a user terminal;
upon completion of the user survey, retrieving survey results from the application on the user terminal;
compiling the survey results with survey results of other users;
determining an alternation to the complex system based on the compiled survey results; and
modifying settings of the complex system to incorporate the alternation.

22. A computer readable medium having a computer program which is executable by a processor for self-optimizing a complex system, the computer readable medium comprising:
an arrangement providing the following:
receiving a service request from an application on a user terminal;
determining whether an alternation has been implemented for the individual user;
retrieving the alternation for the individual user, wherein if the alternation is not implemented a new alternation is created;
applying the alternation or the new alternation to settings of the complex system, wherein the service request is processed; and
transmitting the processed service request and a user survey to the application on the user terminal.

23. A computer readable medium having a computer program which is executable by a processor for self-optimizing a complex system, the computer readable medium comprising:
an arrangement providing the following:
receiving survey results from an individual user on an application on a user terminal;
retrieving an alternation for the individual user;
determining a subset of users that share the alternation; and
determining an efficacy of the alternation for the subset of users.
